(19) United States
(12) Patent Application Publication
(10) Pub. No.: US 2025/0141944 A1
(43) Pub. Date: May 1, 2025

(54) MECHANISM TO AUTHENTICATE THE AVATAR VIA STIR AND SHAKEN

(71) Applicant: Nokia Technologies Oy, Espoo (FI)

(72) Inventors: Saurabh KHARE, Bangalore (IN); Parthasarathi Ravindran, Bangalore (IN); Rainer Liebhart, Munich (DE); Laurent Goix, Massy (FR)

(21) Appl. No.: 18/915,285

(22) Filed: Oct. 14, 2024

(30) Foreign Application Priority Data
Oct. 25, 2023 (IN) 202341072606

(51) Int. Cl. H04L 65/1104; H04L 9/40

(52) U.S. Cl. CPC H04L 65/1104; H04L 63/0807

(57) ABSTRACT

An apparatus including circuitry configured to: receive, from a first user equipment, a session initiation protocol invite request to a second user equipment, wherein the session initiation protocol invite request includes information related to at least one avatar; transmit at least one signing request to a signing server, the at least one signing request including the information related to the at least one avatar as part of a signing process; receive, from the signing server, a response to the at least one signing request, wherein the response to the at least one signing request includes a signed token or other relevant information created during the signing process in relation with the at least one avatar; and forward, to a network entity, the session initiation protocol invite request with an identity header, wherein the identity header includes the signed token or the other relevant information created during the signing process.

### TECHNICAL FIELD

The examples and non-limiting example embodiments relate generally to communications and, more particularly, to a mechanism to authenticate the avatar via stir and shaken.

### BACKGROUND

It is known for two communication devices to participate in a call in a communication network.

### SUMMARY

In accordance with an aspect, an apparatus includes: at least one processor; and at least one memory storing instructions that, when executed by the at least one processor, cause the apparatus at least to: receive, from a first user equipment, a session initiation protocol invite request to a second user equipment, wherein the session initiation protocol invite request comprises information related to at least one avatar; transmit at least one signing request to a signing server, the at least one signing request comprising the information related to the at least one avatar as part of a signing process; receive, from the signing server, a response to the at least one signing request, wherein the response to the at least one signing request comprises a signed token or other relevant information created during the signing process in relation with the at least one avatar; and forward, to a network entity, the session initiation protocol invite request with an identity header, wherein the identity header comprises the signed token or the other relevant information created during the signing process in relation with the at least one avatar.

In accordance with an aspect, an apparatus includes: at least one processor; and at least one memory storing instructions that, when executed by the at least one processor, cause the apparatus at least to: receive, from a network entity, a session initiation protocol invite request with an identity header, wherein the identity header comprises a signed token or other relevant information created during a signing process, wherein the session initiation protocol invite request comprises information related to at least one avatar and is associated with a first user equipment; transmit, to a verification server, a verification request to verify the information related to the at least one avatar, wherein the verification request comprises the identity header comprising the signed token or other relevant information created during the signing process, the session initiation protocol invite request associated with the first user equipment, and the information related to the at least one avatar; receive, from the verification server, an indication of whether the information related to the at least one avatar is verified; and forward, to a second user equipment, the session initiation protocol invite request and the information related to the at least one avatar, in response to receiving an indication from the verification server that the information related to the at least one avatar is verified.

In accordance with an aspect, an apparatus includes: at least one processor; and at least one memory storing instructions that, when executed by the at least one processor, cause the apparatus at least to: receive, from a network entity, a verification request to verify information related to at least one avatar, wherein the verification request comprises an identity header comprising a signed token or other relevant information created during a signing process, a session initiation protocol invite request associated with a first user equipment, and the information related to at least one avatar; determine whether the information related to the at least one avatar is verified, based on the identity header and the information related to the at least one avatar; and transmit, to the network entity, an indication of whether the information related to the at least one avatar is verified.

In accordance with an aspect, an apparatus includes: at least one processor; and at least one memory storing instructions that, when executed by the at least one processor, cause the apparatus at least to: transmit, from a first user equipment to a network entity, a session initiation protocol invite request to a second user equipment, wherein the session initiation protocol invite request comprises information related to at least one avatar as part of a signing process, and wherein the apparatus comprises the first user equipment; and receive, from the network entity, an identity header related to the at least one avatar, the at least one avatar being verified; and store the identity header related to the verified at least one avatar for at least one other session initiation protocol invite request.

In accordance with an aspect, an apparatus includes: at least one processor; and at least one memory storing instructions that, when executed by the at least one processor, cause the apparatus at least to: receive, from a terminating network entity, a session initiation protocol invite request associated with a user equipment and a verified avatar; and download, use, or view information related to the verified avatar with the session initiation protocol invite request associated with the user equipment.

In accordance with an aspect, an apparatus includes: at least one processor; and at least one memory storing instructions that, when executed by the at least one processor, cause the apparatus at least to: receive at least one signing request from a network entity, the at least one signing request comprising information related to at least one avatar as part of a signing process; and transmit, to the network entity, a response to the at least one signing request, wherein the response to the at least one signing request comprises a signed token or other relevant information created during the signing process in relation with the at least one avatar.

### BRIEF DESCRIPTION OF THE DRAWINGS

The foregoing aspects and other features are explained in the following description, taken in connection with the accompanying drawings.

FIG. 1 is a block diagram of one possible and non-limiting system in which the example embodiments may be practiced.

FIG. 2 shows example Ms reference point operation.

FIG. 3 shows an IMS AR communications architecture.

FIG. 4 is a signaling diagram based on the examples described herein.

FIG. 5 is an example apparatus configured to implement the examples described herein.

FIG. 6 shows a representation of an example of non-volatile memory media used to store instructions that implement the examples described herein.

FIG. 7 is an example method, based on the examples described herein.

FIG. 8 is an example method, based on the examples described herein.

FIG. 9 is an example method, based on the examples described herein.

FIG. 10 is an example method, based on the examples described herein.

FIG. 11 is an example method, based on the examples described herein.

FIG. 12 is an example method, based on the examples described herein.

### DETAILED DESCRIPTION OF EXAMPLE EMBODIMENTS

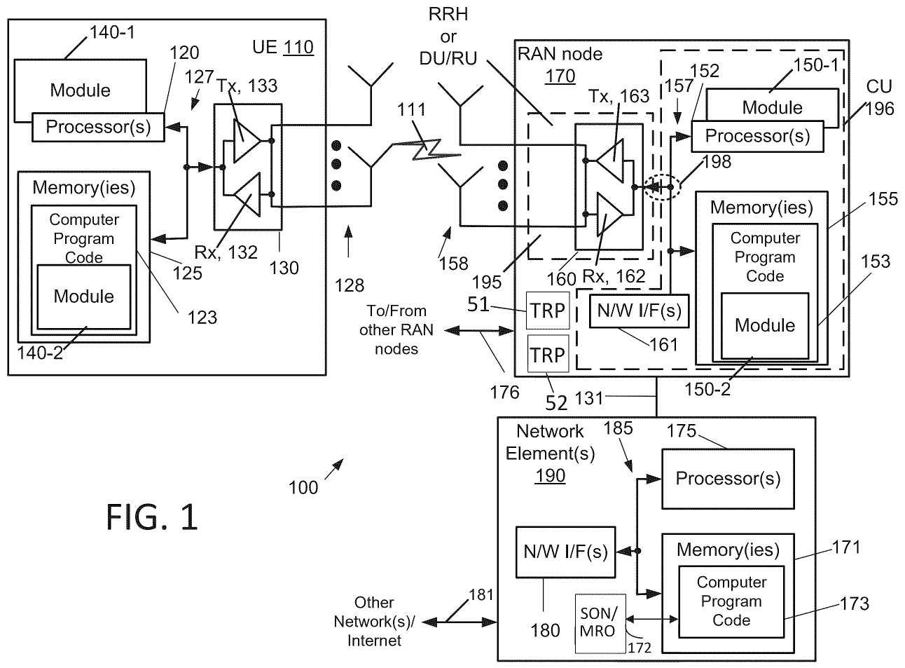

Turning to FIG. 1, this figure shows a block diagram of one possible and non-limiting example in which the examples may be practiced. A user equipment (UE) 110, radio access network (RAN) node 170, and network element(s) 190 are illustrated. In the example of FIG. 1, the user equipment (UE) 110 is in wireless communication with a wireless network 100. A UE is a wireless device that can access the wireless network 100. The UE 110 includes one or more processors 120, one or more memories 125, and one or more transceivers 130 interconnected through one or more buses 127. Each of the one or more transceivers 130 includes a receiver, Rx, 132 and a transmitter, Tx, 133. The one or more buses 127 may be address, data, or control buses, and may include any interconnection mechanism, such as a series of lines on a motherboard or integrated circuit, fiber optics or other optical communication equipment, and the like. The one or more transceivers 130 are connected to one or more antennas 128. The one or more memories 125 include computer program code 123. The UE 110 includes a module 140, comprising one of or both parts 140-1 and/or 140-2, which may be implemented in a number of ways. The module 140 may be implemented in hardware as module 140-1, such as being implemented as part of the one or more processors 120. The module 140-1 may be implemented also as an integrated circuit or through other hardware such as a programmable gate array. In another example, the module 140 may be implemented as module 140-2, which is implemented as computer program code 123 and is executed by the one or more processors 120. For instance, the one or more memories 125 and the computer program code 123 may be configured to, with the one or more processors 120, cause the user equipment 110 to perform one or more of the operations as described herein. The UE 110 communicates with RAN node 170 via a wireless link 111.

The RAN node 170 in this example is a base station that provides access for wireless devices such as the UE 110 to the wireless network 100. The RAN node 170 may be, for example, a base station for 5G, also called New Radio (NR). In 5G, the RAN node 170 may be a NG-RAN node, which is defined as either a gNB or an ng-eNB. A gNB is a node providing NR user plane and control plane protocol terminations towards the UE, and connected via the NG interface (such as connection 131) to a 5GC (such as, for example, the network element(s) 190). The ng-eNB is a node providing E-UTRA user plane and control plane protocol terminations towards the UE, and connected via the NG interface (such as connection 131) to the 5GC. The NG-RAN node may include multiple gNBs, which may also include a central unit (CU) (gNB-CU) 196 and distributed unit(s) (DUs) (gNB-DUs), of which DU 195 is shown. Note that the DU 195 may include or be coupled to and control a radio unit (RU). The gNB-CU 196 is a logical node hosting radio resource control (RRC), SDAP and PDCP protocols of the gNB or RRC and PDCP protocols of the en-gNB that control the operation of one or more gNB-DUs. The gNB-CU 196 terminates the F1 interface connected with the gNB-DU 195. The F1 interface is illustrated as reference 198, although reference 198 also illustrates a link between remote elements of the RAN node 170 and centralized elements of the RAN node 170, such as between the gNB-CU 196 and the gNB-DU 195. The gNB-DU 195 is a logical node hosting RLC, MAC and PHY layers of the gNB or en-gNB, and its operation is partly controlled by gNB-CU 196. One gNB-CU 196 supports one or multiple cells. One cell may be supported with one gNB-DU 195, or one cell may be supported/shared with multiple DUs under RAN sharing. The gNB-DU 195 terminates the F1 interface 198 connected with the gNB-CU 196. Note that the DU 195 is considered to include the transceiver 160, e.g., as part of a RU, but some examples of this may have the transceiver 160 as part of a separate RU, e.g., under control of and connected to the DU 195. The RAN node 170 may also be an eNB (evolved NodeB) base station, for LTE (long term evolution), or any other suitable base station or node.

The RAN node 170 includes one or more processors 152, one or more memories 155, one or more network interfaces (N/W I/F(s)) 161, and one or more transceivers 160 interconnected through one or more buses 157. Each of the one or more transceivers 160 includes a receiver, Rx, 162 and a transmitter, Tx, 163. The one or more transceivers 160 are connected to one or more antennas 158. The one or more memories 155 include computer program code 153. The CU 196 may include the processor(s) 152, one or more memories 155, and network interfaces 161. Note that the DU 195 may also contain its own memory/memories and processor(s), and/or other hardware, but these are not shown.

The RAN node 170 includes a module 150, comprising one of or both parts 150-1 and/or 150-2, which may be implemented in a number of ways. The module 150 may be implemented in hardware as module 150-1, such as being implemented as part of the one or more processors 152. The module 150-1 may be implemented also as an integrated circuit or through other hardware such as a programmable gate array. In another example, the module 150 may be implemented as module 150-2, which is implemented as computer program code 153 and is executed by the one or more processors 152. For instance, the one or more memories 155 and the computer program code 153 are configured to, with the one or more processors 152, cause the RAN node 170 to perform one or more of the operations as described herein. Note that the functionality of the module 150 may be distributed, such as being distributed between the DU 195 and the CU 196, or be implemented solely in the DU 195.

The one or more network interfaces 161 communicate over a network such as via the links 176 and 131. Two or more gNBs 170 may communicate using, e.g., link 176. The link 176 may be wired or wireless or both and may implement, for example, an Xn interface for 5G, an X2 interface for LTE, or other suitable interface for other standards.

The one or more buses 157 may be address, data, or control buses, and may include any interconnection mechanism, such as a series of lines on a motherboard or integrated circuit, fiber optics or other optical communication equipment, wireless channels, and the like. For example, the one or more transceivers 160 may be implemented as a remote radio head (RRH) 195 for LTE or a distributed unit (DU) 195 for gNB implementation for 5G, with the other elements of the RAN node 170 possibly being physically in a different location from the RRH/DU 195, and the one or more buses 157 could be implemented in part as, for example, fiber optic cable or other suitable network connection to connect the other elements (e.g., a central unit (CU), gNB-CU 196) of the RAN node 170 to the RRH/DU 195. Reference 198 also indicates those suitable network link(s).

A RAN node/gNB can comprise one or more TRPs to which the methods described herein may be applied. FIG. 1 shows that the RAN node 170 comprises TRP 51 and TRP 52, in addition to the TRP represented by transceiver 160. Similar to transceiver 160, TRP 51 and TRP 52 may each include a transmitter and a receiver. The RAN node 170 may host or comprise other TRPs not shown in FIG. 1.

A relay node in NR is called an integrated access and backhaul node. A mobile termination part of the IAB node facilitates the backhaul (parent link) connection. In other words, the mobile termination part comprises the functionality which carries UE functionalities. The distributed unit part of the IAB node facilitates the so called access link (child link) connections (i.e. for access link UEs, and backhaul for other IAB nodes, in the case of multi-hop IAB). In other words, the distributed unit part is responsible for certain base station functionalities. The IAB scenario may follow the so called split architecture, where the central unit hosts the higher layer protocols to the UE and terminates the control plane and user plane interfaces to the 5G core network.

It is noted that the description herein indicates that “cells” perform functions, but it should be clear that equipment which forms the cell may perform the functions. The cell makes up part of a base station. That is, there can be multiple cells per base station. For example, there could be three cells for a single carrier frequency and associated bandwidth, each cell covering one-third of a 360 degree area so that the single base station's coverage area covers an approximate oval or circle. Furthermore, each cell can correspond to a single carrier and a base station may use multiple carriers. So if there are three 120 degree cells per carrier and two carriers, then the base station has a total of 6 cells.

The wireless network 100 may include a network element or elements 190 that may include core network functionality, and which provides connectivity via a link or links 181 with a further network, such as a telephone network and/or a data communications network (e.g., the Internet). Such core network functionality for 5G may include location management functions (LMF(s)) and/or access and mobility management function(s) (AMF(S)) and/or user plane functions (UPF(s)) and/or session management function(s) (SMF(s)). Such core network functionality for LTE may include MME (mobility management entity)/SGW (serving gateway) functionality. Such core network functionality may include SON (self-organizing/optimizing network) functionality. These are merely example functions that may be supported by the network element(s) 190, and note that both 5G and LTE functions might be supported. The RAN node 170 is coupled via a link 131 to the network element 190. The link 131 may be implemented as, e.g., an NG interface for 5G, or an S1 interface for LTE, or other suitable interface for other standards. The network element 190 includes one or more processors 175, one or more memories 171, and one or more network interfaces (N/W I/F(s)) 180, interconnected through one or more buses 185. The one or more memories 171 include computer program code 173. Computer program code 173 may include SON and/or MRO functionality 172.

The wireless network 100 may implement network virtualization, which is the process of combining hardware and software network resources and network functionality into a single, software-based administrative entity, or a virtual network. Network virtualization involves platform virtualization, often combined with resource virtualization. Network virtualization is categorized as either external, combining many networks, or parts of networks, into a virtual unit, or internal, providing network-like functionality to software containers on a single system. Note that the virtualized entities that result from the network virtualization are still implemented, at some level, using hardware such as processors 152 or 175 and memories 155 and 171, and also such virtualized entities create technical effects.

The computer readable memories 125, 155, and 171 may be of any type suitable to the local technical environment and may be implemented using any suitable data storage technology, such as semiconductor based memory devices, flash memory, magnetic memory devices and systems, optical memory devices and systems, non-transitory memory, transitory memory, fixed memory and removable memory. The computer readable memories 125, 155, and 171 may be means for performing storage functions. The processors 120, 152, and 175 may be of any type suitable to the local technical environment, and may include one or more of general purpose computers, special purpose computers, microprocessors, digital signal processors (DSPs) and processors based on a multi-core processor architecture, as non-limiting examples. The processors 120, 152, and 175 may be means for performing functions, such as controlling the UE 110, RAN node 170, network element(s) 190, and other functions as described herein.

In general, the various example embodiments of the user equipment 110 can include, but are not limited to, cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback devices having wireless communication capabilities, internet appliances including those permitting wireless internet access and browsing, tablets with wireless communication capabilities, head mounted displays such as those that implement virtual/augmented/mixed reality, as well as portable units or terminals that incorporate combinations of such functions. The UE 110 can also be a vehicle such as a car, or a UE mounted in a vehicle, a UAV such as e.g. a drone, or a UE mounted in a UAV. The user equipment 110 may be terminal device, such as mobile phone, mobile device, sensor device etc., the terminal device being a device used by the user or not used by the user.

UE 110, RAN node 170, and/or network element(s) 190, (and associated memories, computer program code and modules) may be configured to implement (e.g. in part) the methods described herein. Thus, computer program code 123, module 140-1, module 140-2, and other elements/features shown in FIG. 1 of UE 110 may implement user equipment related aspects of the examples described herein. Similarly, computer program code 153, module 150-1, module 150-2, and other elements/features shown in FIG. 1 of RAN node 170 may implement gNB/TRP related aspects of the examples described herein. Computer program code 173 and other elements/features shown in FIG. 1 of network element(s) 190 may be configured to implement network element related aspects of the examples described herein.

Having thus introduced a suitable but non-limiting technical context for the practice of the example embodiments, the example embodiments are now described with greater specificity.

The Ms reference point as described in TS 24.229 (refer for example to Annex V.2) is used to request signing of an identity header field or request verification of a signed assertion in an identity header field. This enables calling number verification using signature verification and attestation information based on the STIR/SHAKEN framework. This is particularly important for robocalls e.g. to label potential spam calls.

The existing Ms reference point and procedures as described in TS 24.229 is used for signing and verifying other identities than for example the ones in the P-Asserted-Identity header field which are mainly in the format of a SIP URI or Tel URL.

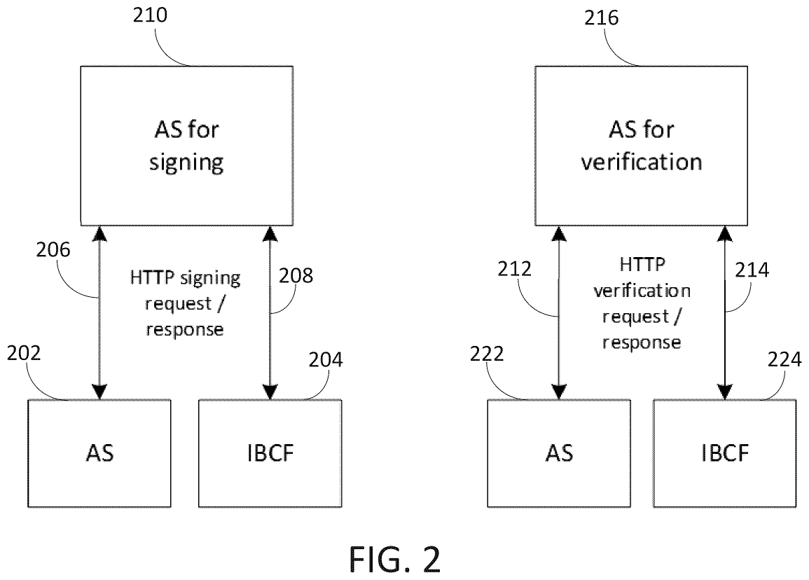

FIG. 2 shows the use of the Ms reference point for signing and verification of identities in SIP header fields using an AS (STI-AS) for signing 210 at the originating side and an AS (STI-VS) 216 for verification at the terminating side. For verification of the calling line identity the IBCF 204 or an AS 202 of the originating network sends an HTTP signing request (206, 208) to the signing AS 210 which in turn replies (206, 208) with a Personal Assertion Token (PASSporT). At the terminating network side, the IBCF 224 or an AS 222 sends an HTTP verification request (212, 214) to the signing AS 216 including the PASSporT which in turn replies with a verification success or failure message (212, 214).

Securing the display name of a caller was outside the scope of Secure Telephone Identity Revisited (STIR) while IETF draft-ietf-stir-passport-red-26 documents an optional mechanism for PASSporT and the associated STIR procedures allowing to sign and verify additional data elements including for example: the name of the calling person or of an entity; the traditional caller ID along with related display information that would be rendered to the called party during alerting; hyperlinks to images, such as logos or pictures of faces, or to similar external profile information; information related to the location of the caller; information related to an organization the caller is associated with, or categories or departments of organizations and institutions; and possibly other Rich Call Data (RCD) information elements.

### Signing Request/Response Example:

### Request Sample:

```
POST /stir/v1/signing HTTP/1.1
Host : stir.att.com
Accept : application/json
X-RequestID: AA97B177-9383-4934-8543-0F91A7A02836
Content-Type: application/json 6.
Content-Length : ...
  { ″signingRequest”: {
    ″attest″: “A”,
    ″orig”: { “tn”: “12155551212” },
    “dest”: { “tn” : [ “12355551212” ] },
    ″iat”: 1443208345,
    “origid”: “de305d54-75b4-431b-adb2-eb6b9e546014”
} }
```

### Response Sample (Success):

```
HTTP/1.1 200 Ok
X-RequestID: AA97B177-9383-4934-8543-0F91A7A02836
Content-Type : application/json
Content-Length : ...
  { ″signingResponse″: {
    ″identity″ :
    “eyJhbGciOiJFUzI1NiIsInR5cCI6InBhc3Nwb3J0IiwicHB0Ijoic2hha2VuIiwi
    eDV1IjoiaHR0cDov
    L2NlcnQtYXV0aC5wb2Muc31zLmNvbWNhc3QubmV0L2V4YW1wbGUuY2VydCJ9eyJhd
    HRlc3Qi
    OiJBIiwiZGVzdCI6eyJ0biI6IisxMjEINTU1MTIxMyJ9LCJpYXQiOiIxNDcxMzc1N
    DE4Iiwib3JpZyI6eyJ
    0biI64oCdKzEyMTU1NTUxMjEyIn0sIm9yaWdpZCI6IjEyM2U0NTY3LWU4OWItMTJk
    My1hNDU2
    LTQyNjY1NTQ0MDAwMCJ9._28kAwRWnheXyA6nY4MvmK5JKHZH9hSYkWI4g75mnq9T
    j2lW4 WPm0PlvudoGaj7wM5XujZUTb_3MA4modoDtCA;info=;alg=ES256”
} }
```

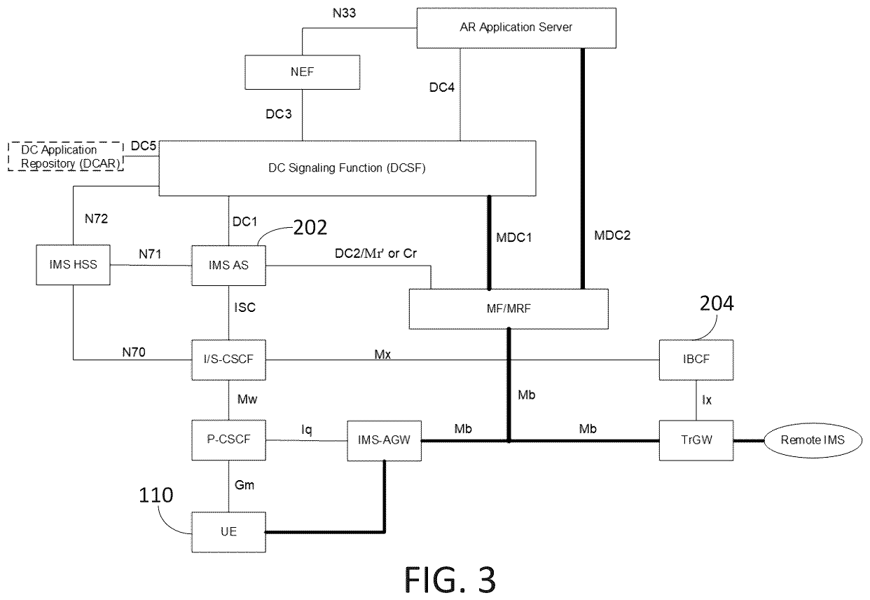

In 3GPP Rel19 TS 22.261 Clause 6.39 5G IMS Multimedia Telephony Service extends for new type of devices like AR/VR/XR which can bring promising improvements to IMS services. TS 23.228 AC.9 provides the support of AR communication. FIG. 3 shows an example IMS AR communications architecture. A Digital Asset Container (DAC), not shown in FIG. 3, is used for storing and retrieving the avatar model. A DAC can be inside or outside the 5GC.

In TS22.156, 3GPP SA1 has defined various requirements with respect to avatar calls, which include (1-7):

1. Subject to user consent, the 5G system (including IMS) shall support multimedia conversational communications between two or more users including transfer of real time avatar media and audio media. Avatar media can be transmitted on both uplink and downlink. Confidentiality of the data used to produce the avatar (e.g. from the UE cameras, etc.) is assumed.

2. Subject to user consent, the 5G system (including IMS) shall support change of media types between video and avatar media for parties of a multimedia conversational communication.

3. The 5G system (including IMS) shall support transcoding between media such as text, video and avatar media in multimedia conversational communications. Text, video or other media could allow a party to control the appearance of its avatar, e.g. to express behavior, movement, affect, emotions, etc. The transcoding of media enables avatar communication, e.g. in scenarios in which a UE participating in an IMS call or other service does not support e.g. FACS, encoding avatar media, generating avatar media, etc.

4. Subject to operator policy, regulatory requirements and user consent, the 5G system (including IMS) shall support the capabilities of rendering the avatar based on the body movement information (e.g. body motion or facial expression) of a human user.

5. The 5G system (including IMS) shall support the encoding of sensor data capturing the facial expression and movement and gestures of a person, in a standard form. The actual transmission and rendering of facial expression and movement and gestures of a person within a multimedia conversational communication is subject to that person's consent.

6. Subject to operator policy, regulatory requirements and user consent and operator policy, the 5G system shall be able to authorize the avatar to be used in mobile metaverse services.

7. Subject to regulatory requirements, user consent and operator policy, the 5G system shall provide time-bound authorization for specified subscribers to use an avatar in mobile metaverse services.

And with respect to digital assets (including avatar) (1-2):

1. Subject to user consent, regulatory requirements and operator policy, the 5G system shall provide secure means to authorize the use of digital assets associated with a user (e.g. digital assets belonging to a third party customer).

2. The 5G system shall provide mechanisms to certify the authenticity of digital assets associated with a user.

Digital asset container management may provide solutions to securely manage representative symbols and other media. IMS avatar calling may also be implemented, and the examples described herein address avatar representation identification. For example, STIR and SHAKEN with rich data or third-party identity and identification may be implemented, considering as part of such information an avatar ID or an avatar file. Similarly, the associated behavior based on whether the avatar information has been verified may be defined in the IMS. Accordingly, the examples described herein relate to stir and shaken based avatar authentication and associated system aspects and solutions, and stir and shaken enhancement for avatar calling.

As defined in the SA1 metaverse TR 22.156 (see clause 7.2): subject to operator policy, regulatory requirements and user consent and operator policy, the 5G system shall be able to authorize the avatar to be used in mobile metaverse services, subject to regulatory requirements, user consent and operator policy, the 5G system shall provide time-bound authorization for specified subscribers to use an avatar in mobile metaverse services, subject to user consent, regulatory requirements and operator policy, the 5G system shall provide secure means to authorize the use of digital assets associated with a user (e.g. digital assets belonging to a third party customer), and the 5G system shall provide mechanisms to certify the authenticity of digital assets associated with a user.

Celebrity or political leaders may use patented or copyright avatars to avoid any misuse of their avatar. However, in the IMS call, the network should ensure that the user is allowed to use their own avatar only, and the network should not allow the user to use other patented or copyrighted avatars.

Furthermore, care should be taken that avatar representations are not hijacked, e.g. replaced by another content or representation while their ID is the same: their integrity has thus to be protected.

It is further expected that A2P calls develop in the context of avatar calls e.g. for customer service, or potential telemarketing calls, including robocalls made with an avatar and prerecorded voice. Thus the trusted identification of the avatar is important in that context to avoid unwanted avatar calls. The examples described herein leverage a STIR and/or SHAKEN framework in IMS to authenticate use of the avatar used by the user in IMS avatar calls.

### Main Assumptions and Definitions

Avatar metadata or an avatar representation is the 2D or 3D representational content or model of an avatar stored in a file which can be accessed via a URL. The avatar metadata or representation may correspond to a face or full body or portion of a body. Avatar representations are stored in a Digital Asset Container (DAC). The DAC can be internal to the PLMN, for example as a new NF or part of an NF (e.g. HSS or UDM, IMS AS), a XR application server or a web server within the IMS and/or 5GC, or external to the PLMN (e.g. on a web server of a cloud provider). There may be potential security issues implied by retrieving the avatar representation from an external storage. Additional metadata may be associated with the avatar representation (for example format, resolution, access or usage rights and times, date of creation, licensing etc.). Candidate technologies for an avatar model can be for example glTF or VRM.

It is assumed that avatar representations, or a reference to them (for example an avatar ID) are associated per subscriber and/or per subscriber's user identity (i.e. assuming multiple user identities per subscriber, for example personal and/or professional). Additional metadata can be associated with the avatar ID-user association (for example access or usage rights and times etc.).

Multiple avatar representations can be stored per subscriber, each of them addressable via an avatar ID. The avatar ID can be for example an integer, string, UUID, a URI (URN or URL). When in the form of a URI, the avatar ID can take the form of a dereferenceable URI, thus allowing to easily retrieve the associated avatar representation. Other means such as for example via Webfinger or Host-meta or LRDD protocols, or from a predefined server, can be used to retrieve the avatar representation based on the avatar ID.

Possibly, different alternative versions (e.g., format/technology, resolution etc.) of the avatar representation could be provided.

Main solution principles described herein:

An originating UE or the network can fetch and add the avatar ID to an IMS call, e.g., via SIP or SDP signaling. For example, the user can select an avatar from a web page of possible or allowed avatars and use the corresponding avatar URL as an ID. The allowed avatar IDs (URLs) can also be stored as part of the user's subscription data in the network (UDM/HSS).

The network checks that the user is authorized to use the avatar ID provided by the originating UE in SIP or SDP signaling or trusts the user (e.g., an enterprise) that the provided avatar ID is allowed for that user. The IMS can check the avatar ID by contacting the (trusted) 3^{rd} party where the avatars are stored and provide the user's ID (for example, IMPU) and the selected avatar ID.

Furthermore, the calling party avatar has to be integrity-protected and is thus signed. For signing of the calling party avatar, the IBCF or an AS of the originating network sends a HTTP signing request that includes the avatar identity (for example, the avatar URI) and avatar content to the signing AS which in turn replies with a Personal Assertion Token (PASSporT) that is forwarded to the terminating side in SIP signaling.

The signing request may look like:

| | |
|---|---|
| ◯ | {″signingRequest”: |
| | ▪ { ″attest″: “A”, |
| | ▪ ″orig”: |

| | |
|---|---|
| ● | { “tn”: “12155551212” }, |
| ● | “dest”: { “tn” : [ “12355551212” ] }, |
| ● | ″iat”: 1443208345, |
| ● | “origid”: “de305d54-75b4-431b-adb2-eb6b9e546014” , |
| ▪ | Avatar ID(s) /Avatar URI(s) [pass-by-reference, preferably] |
| | Or Avatar content (e.g. binary base64 data) [pass-by-value] |
| } | |

As can be seen in the above example, the one or more avatar identifiers and the one or more avatar uniform resource identifiers are passed by reference, which is preferred (in other examples the one or more avatar identifiers and the one or more avatar uniform resource identifiers may be passed by value), and the avatar content is passed by value (in other examples the avatar content may be passed by reference).

The signing response with identity (enhanced token) will include one or more avatar IDs or one or more avatar URIs or avatar content. The avatar ID, or the avatar URI, or the avatar content can be provided in the Call-Info header.

Additionally, the Call-info header and calling party number can be signed separately.

At the terminating network side, the IBCF or an AS sends an HTTP verification request to the verification AS including the received PASSporT which in turn replies with a verification success or failure message. If verification of the enhanced token is successful, the included one or more avatar IDs or the one or more Avatar URIs or the avatar content matches or match with the avatar that was selected by the A party (where the A party is the party originating the invite request). Based on the provided avatar ID, the B party (where the B party is the recipient of the invite) can download the avatar for use in the IMS avatar call.

The originating network can send the signed token or passport to the UE so that the UE can cache the signed token along with the avatar Id and use it for further communication. This avoids a further signing request to the signing server.

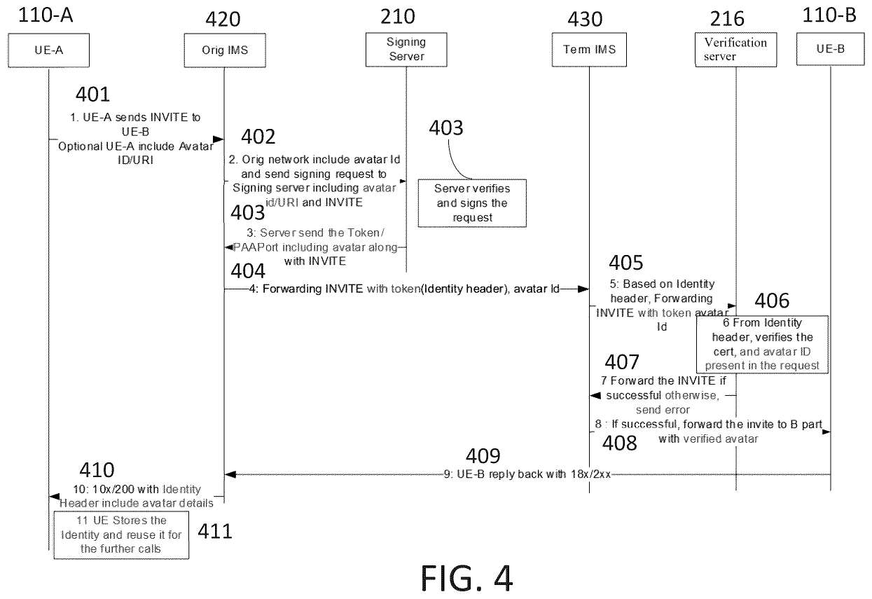

FIG. 4 is a signaling diagram showing the aspects of the herein described methods. In particular, FIG. 4 shows a signaling exchange between UE-A 110-A, original IMS 420, signing server 210, terminating IMS 430, verification server 216, and UE-B 110-B.

Step 1 (401): UE-A sends an INVITE request to the originating IMS network that includes an avatar ID or an avatar URI or avatar content, for example in a Call-Info header as RCD. Alternatively, the IMS AS can add the avatar ID that is available or stored in the network.

Step 2 (402): If the passport or token is not available with the avatar ID (previously cached in the UE 110-A), the IMS network 420 sends a signing request to signing server 210 that includes the avatar ID or the avatar URI or the avatar content. It is aligned with STIR and SHAKEN standards and RFC.

If there are multiple avatars provided in the INVITE request, then the IMS network sends multiple requests, each carrying a single avatar-related information item.

A request sample may look like:

| ◯ | { ″signingRequest”: | |
|---|---|---|
| | ▪ | { ″attestv: “A”. |

| | |
|---|---|
| ● | ″orig”: { “tn”: “12155551212” }, |
| ● | “dest”: { “tn” : [ “12355551212” ] }, |
| ● | ″iat”: 1443208345, |
| ● | “origid”: “de305d54-75b4-431b-adb2-eb6b9e546014” , |
| ● | Avatar ID(s) /Avatar URI (s) [pass-by-reference, preferably] |
| | Or Avatar content (e.g. binary base64 data) [pass-by-value] |

}

}

As can be seen in the above example, the one or more avatar identifiers and the one or more avatar uniform resource identifiers are passed by reference, which is preferred (in other examples the one or more avatar identifiers and the one or more avatar uniform resource identifiers may be passed by value), and the avatar content is passed by value (in other examples the avatar content may be passed by reference).

The signing request may be dedicated to the avatar information, and be different, for example different from the calling party ID signing request.

Step 3 (403): The signing server 210 verifies the request and sends the response to the originating IMS network 420. The response includes the token or passport to be used in the identity header. This header has avatar details as well. The response sample may look like:

```
  HTTP/1.1 200 Ok
  X-RequestID: AA97B177-9383-4934-8543-0F91A7A02836
  Content-Type : application/json
  Content-Length : ...
    { ″signingResponse″: {
      ″identity″ :
      “eyJhbGciOiJFUzI1NiIsInR5cCI6InBhc3Nwb3J0IiwicHB0Ijoic2hha2VuIiwieD
      V1IjoiaHR0cDov
      L2NlcnQtYXV0aC5wb2Muc3lzLmNvbWNhc3QubmV0L2V4YW1wbGUuY2V
      ydCJ9eyJhdHRlc3Qi
      OiJBIiwiZGVzdCI6eyJ0biI6IisxMjE1NTU1MTIxMyJ9LCJpYXQiOiIxNDcxMz
      c1NDE4Iiwib3JpZyI6eyJ
      0biI64oCdKzEyMTU1NTUxMjEyIn0sIm9yaWdpZCI6IjEyM2U0NTY3LWU4O
      WItMTJkMy1hNDU2
      LTQyNjY1NTQ0MDAwMCJ9._28kAwRWnheXyA6nY4MvmK5JKHZH9hSYk
      WI4g75mnq9Tj21W4
      WPm0PlvudoGaj7wM5XujZUTb_3MA4modoDtCA;info=;alg=ES256”,
      ppt=″rcd″
} }
```

Before signing the original IMS 420 must be sure that the UE 110-A is allowed to provide the avatar. Either the avatar is trusted per se, or the avatar is fetched from a trusted external entity or stored inside the network (in HSS)) itself and fetched from there. The signing server 210 generates the token based on certificates and header content. The IMS network (420, 430) must trust the content. It is the same with the telephone number the UE 110A is providing, as the number is stored in HSS it is trusted (or asserted).

Step 4 (404), 5 (405): The originating network 420 forwards the INVITE request to the terminating network 430 with the enhanced token in the Identity header. If there are multiple avatars provided in the INVITE request, then there are multiple Identity headers, each carrying a single avatar-related information item.

Now, terminating network 430 sends a request to verification server 216 to validate the identity header.

Step 6 (406), 7 (407): Verification server 216 follows the STIR and SHAKEN RFC and validates the content of the one or more Identity headers. Additionally, if the avatar ID or the avatar URI or the avatar content available in the Identity header is matched with the avatar ID or the avatar URI or the avatar content available in the request, then the identity header and/or the avatar related information is considered valid and the verification server sends a positive reply. Otherwise, the verification server sends an error.

Alternatively, if only the avatar (identity header dedicated to avatar, for example using parameter ppt=“red”) fails in validation, but for example the originating party identity (From) is valid, then the terminating network 430 can allow the call to continue without an avatar.

Step 8 (408), 9 (409): Terminating IMS network 430 forwards the INVITE to UE-B 110-B and after receiving a response from UE-B, it (terminating IMS network 430) forwards the response to UE-A 110-A that goes via originating IMS network 420. If the avatar could not be verified, then the IMS network 430 can have different behaviors based on configuration (1-3):
1. Reject the call without informing UE-B 110-B;
2. Remove the avatar media (for example only allow the audio call) but still forward the call to UE-B (for example if UE-A identity was verified positively via a separate token related to the originating party ID);
3. Forward the call to UE-B with the indication that the avatar could not be verified (or without the indication that it was verified). In this case UE-B informs the B user that this may be a spam or spoofed avatar, and UE-B may not try to download or display the avatar during incoming call ringing or setup.

Only if the avatar URI is verified then terminating network 430 and/or UE-B 110-B can download the verified avatar from the URL and present the avatar to the terminating party B.

Step 10 (410), 11 (411): originating network 420 can add an SIP Identity header related to the verified avatar to UE-A 110-A, so that UE-A can cache the SIP Identity header related to the verified avatar and further use the SIP Identity header related to the verified avatar for subsequent calls. Note that other SIP Identity headers related for example to the verified calling party identity can be added as well towards UE-A.

The examples described herein may be part of 3GPP standards, such as 3GPP Rel-19 standards.

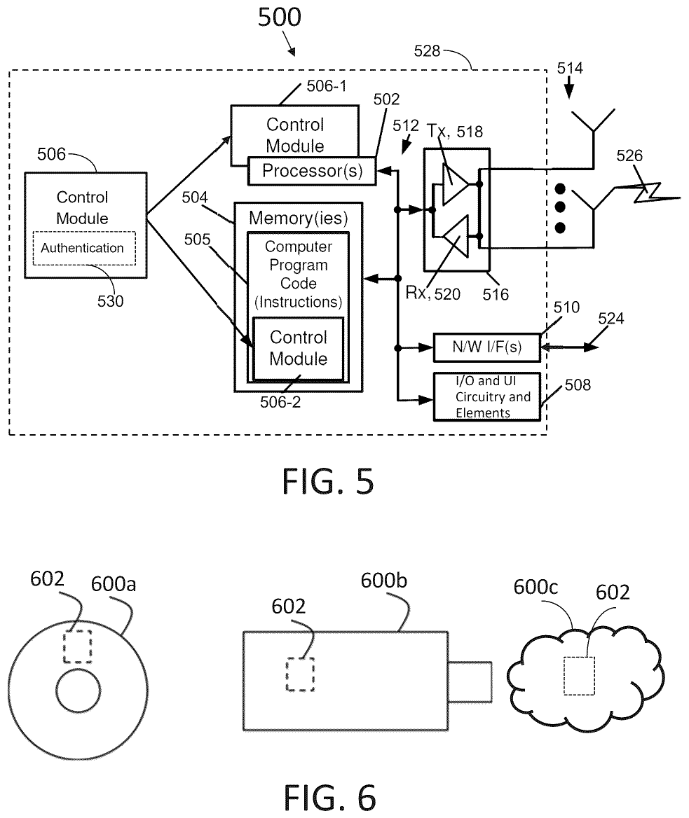

FIG. 5 is an example apparatus 500, which may be implemented in hardware, configured to implement the examples described herein. The apparatus 500 comprises at least one processor 502 (e.g. an FPGA and/or CPU), one or more memories 504 including computer program code 505, the computer program code 505 having instructions to carry out the methods described herein, wherein the at least one memory 504 and the computer program code 505 are configured to, with the at least one processor 502, cause the apparatus 500 to implement circuitry, a process, component, module, or function (implemented with control module 506) to implement the examples described herein. The memory 504 may be a non-transitory memory, a transitory memory, a volatile memory (e.g. RAM), or a non-volatile memory (e.g. ROM). Optionally included authentication 530 of the control module implements the herein described aspects related to authenticating an avatar via stir and shaken.

The apparatus 500 includes a display and/or I/O interface 508, which includes user interface (UI) circuitry and elements, that may be used to display aspects or a status of the methods described herein (e.g., as one of the methods is being performed or at a subsequent time), or to receive input from a user such as with using a keypad, camera, touchscreen, touch area, microphone, biometric recognition, one or more sensors, etc. The apparatus 500 includes one or more communication e.g. network (N/W) interfaces (I/F(s)) 510. The communication I/F(s) 510 may be wired and/or wireless and communicate over the Internet/other network(s) via any communication technique including via one or more links 524. The link(s) 524 may be the link(s) 131 and/or 176 from FIG. 1. The link(s) 131 and/or 176 from FIG. 1 may also be implemented using transceiver(s) 516 and corresponding wireless link(s) 526. The communication I/F(s) 510 may comprise one or more transmitters or one or more receivers.

The transceiver 516 comprises one or more transmitters 518 and one or more receivers 520. The transceiver 516 and/or communication I/F(s) 510 may comprise standard well-known components such as an amplifier, filter, frequency-converter, (de) modulator, and encoder/decoder circuitries and one or more antennas, such as antennas 514 used for communication over wireless link 526.

The control module 506 of the apparatus 500 comprises one of or both parts 506-1 and/or 506-2, which may be implemented in a number of ways. The control module 506 may be implemented in hardware as control module 506-1, such as being implemented as part of the one or more processors 502. The control module 506-1 may be implemented also as an integrated circuit or through other hardware such as a programmable gate array. In another example, the control module 506 may be implemented as control module 506-2, which is implemented as computer program code (having corresponding instructions) 505 and is executed by the one or more processors 502. For instance, the one or more memories 504 store instructions that, when executed by the one or more processors 502, cause the apparatus 500 to perform one or more of the operations as described herein. Furthermore, the one or more processors 502, the one or more memories 504, and example algorithms (e.g., as flowcharts and/or signaling diagrams), encoded as instructions, programs, or code, are means for causing performance of the operations described herein.

The apparatus 500 to implement the functionality of control 506 may be UE 110, RAN node 170 (e.g. gNB), or network element(s) 190 (e.g. LMF 190). Thus, processor 502 may correspond to processor(s) 120, processor(s) 152 and/or processor(s) 175, memory 504 may correspond to one or more memories 125, one or more memories 155 and/or one or more memories 171, computer program code 505 may correspond to computer program code 123, computer program code 153, and/or computer program code 173, control module 506 may correspond to module 140-1, module 140-2, module 150-1, and/or module 150-2, and communication I/F(s) 510 and/or transceiver 516 may correspond to transceiver 130, antenna(s) 128, transceiver 160, antenna(s) 158, N/W I/F(s) 161, and/or N/W I/F(s) 180. Alternatively, apparatus 500 and its elements may not correspond to either of UE 110, RAN node 170, or network element(s) 190 and their respective elements, as apparatus 500 may be part of a self-organizing/optimizing network (SON) node or other node, such as a node in a cloud.

Apparatus 500 may also correspond to UE-A 110-A (which UE-A 110-A may be configured similar to UE 110), original IMS 420, signing server 210, terminating IMS 430, verification server 216, or UE-B 110-B (which UE-B 110-B may be configured similar to UE 110).

The apparatus 500 may also be distributed throughout the network (e.g. 100) including within and between apparatus 500 and any network element (such as a network control element (NCE) 190 and/or the RAN node 170 and/or UE 110).

Interface 512 enables data communication and signaling between the various items of apparatus 500, as shown in FIG. 5. For example, the interface 512 may be one or more buses such as address, data, or control buses, and may include any interconnection mechanism, such as a series of lines on a motherboard or integrated circuit, fiber optics or other optical communication equipment, and the like. Computer program code (e.g. instructions) 505, including control 506 may comprise object-oriented software configured to pass data or messages between objects within computer program code 505. The apparatus 500 need not comprise each of the features mentioned, or may comprise other features as well. The various components of apparatus 500 may at least partially reside in a common housing 528, or a subset of the various components of apparatus 500 may at least partially be located in different housings, which different housings may include housing 528.

FIG. 6 shows a schematic representation of non-volatile memory media 600a (e.g. computer/compact disc (CD) or digital versatile disc (DVD)) and 600b (e.g. universal serial bus (USB) memory stick) and 600c (e.g. cloud storage for downloading instructions and/or parameters 602 or receiving emailed instructions and/or parameters 602) storing instructions and/or parameters 602 which when executed by a processor allows the processor to perform one or more of the steps of the methods described herein. Instructions and/or parameters 602 may represent a non-transitory computer readable medium.

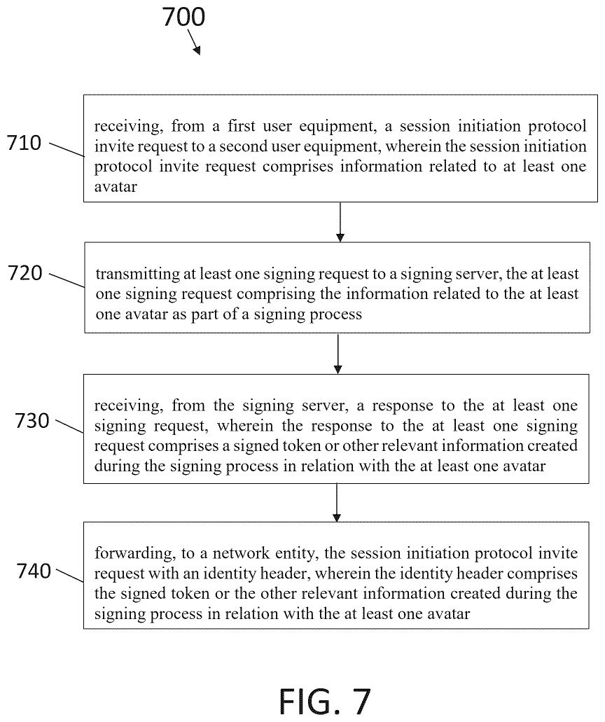

FIG. 7 is an example method 700, based on the example embodiments described herein. At 710, the method includes receiving, from a first user equipment, a session initiation protocol invite request to a second user equipment, wherein the session initiation protocol invite request comprises information related to at least one avatar. At 720, the method includes transmitting at least one signing request to a signing server, the at least one signing request comprising the information related to the at least one avatar as part of a signing process. At 730, the method includes receiving, from the signing server, a response to the at least one signing request, wherein the response to the at least one signing request comprises a signed token or other relevant information created during the signing process in relation with the at least one avatar. At 740, the method includes forwarding, to a network entity, the session initiation protocol invite request with an identity header, wherein the identity header comprises the signed token or the other relevant information created during the signing process in relation with the at least one avatar. Method 700 may be performed with originating IMS 420, RAN node 170, one or more network elements 190, or apparatus 500.

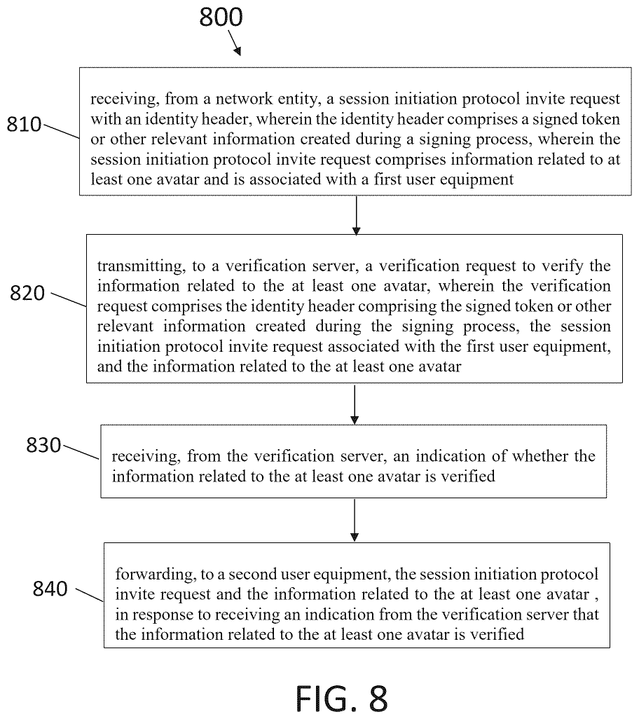

FIG. 8 is an example method 800, based on the example embodiments described herein.

At 810, the method includes receiving, from a network entity, a session initiation protocol invite request with an identity header, wherein the identity header comprises a signed token or other relevant information created during a signing process, wherein the session initiation protocol invite request comprises information related to at least one avatar and is associated with a first user equipment. At 820, the method includes transmitting, to a verification server, a verification request to verify the information related to the at least one avatar, wherein the verification request comprises the identity header comprising the signed token or other relevant information created during the signing process, the session initiation protocol invite request associated with the first user equipment, and the information related to the at least one avatar. At 830, the method includes receiving, from the verification server, an indication of whether the information related to the at least one avatar is verified. At 840, the method includes forwarding, to a second user equipment, the session initiation protocol invite request and the information related to the at least one avatar, in response to receiving an indication from the verification server that the information related to the at least one avatar is verified. Method 800 may be performed with terminating IMS 430, RAN node 170, one or more network elements 190, or apparatus 500.

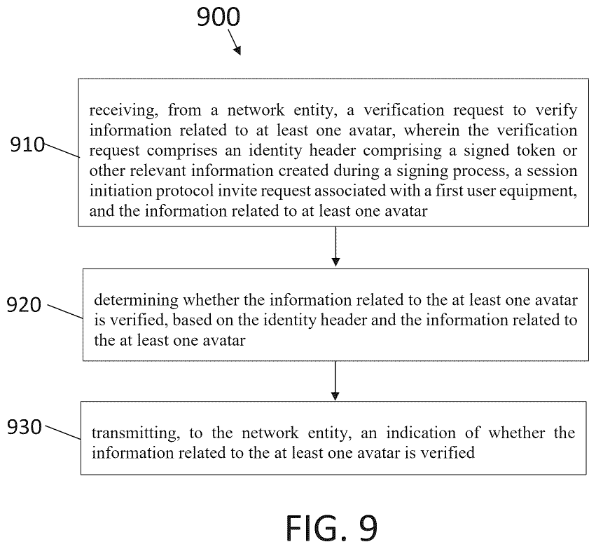

FIG. 9 is an example method 900, based on the example embodiments described herein. At 910, the method includes receiving, from a network entity, a verification request to verify information related to at least one avatar, wherein the verification request comprises an identity header comprising a signed token or other relevant information created during a signing process, a session initiation protocol invite request associated with a first user equipment, and the information related to at least one avatar. At 920, the method includes determining whether the information related to the at least one avatar is verified, based on the identity header and the information related to the at least one avatar. At 930, the method includes transmitting, to the network entity, an indication of whether the information related to the at least one avatar is verified. Method 900 may be performed with verification server 216, RAN node 170, one or more network elements 190, or apparatus 500.

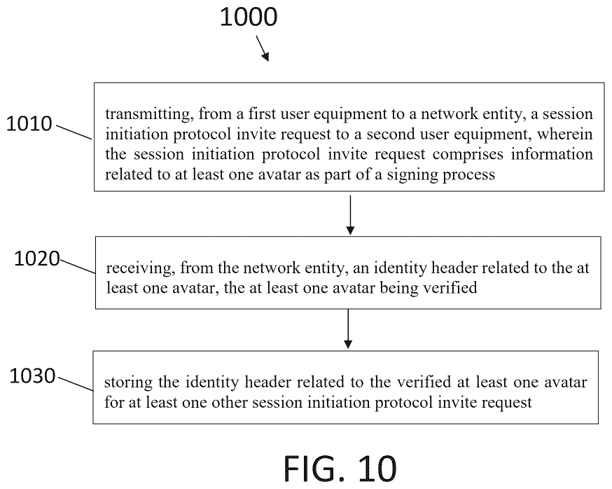

FIG. 10 is an example method 1000, based on the example embodiments described herein. At 1010, the method includes transmitting, from a first user equipment to a network entity, a session initiation protocol invite request to a second user equipment, wherein the session initiation protocol invite request comprises information related to at least one avatar as part of a signing process. At 1020, the method includes receiving, from the network entity, an identity header related to the at least one avatar, the at least one avatar being verified. At 1030, the method includes storing the identity header related to the verified at least one avatar for at least one other session initiation protocol invite request. Method 1000 may be performed with UE-A 110-A, UE 110, or apparatus 500.

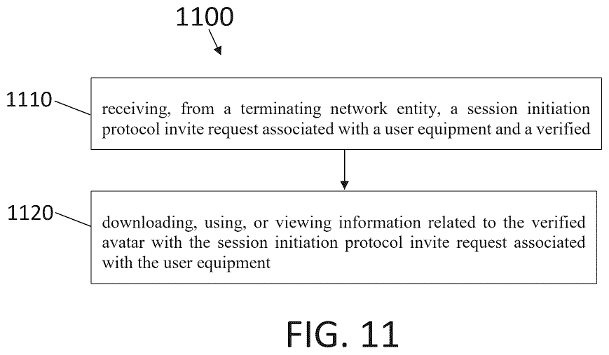

FIG. 11 is an example method 1100, based on the example embodiments described herein. At 1110, the method includes receiving, from a terminating network entity, a session initiation protocol invite request associated with a user equipment and a verified avatar. At 1120, the method includes downloading, using, or viewing information related to the verified avatar with the session initiation protocol invite request associated with the user equipment. Method 1100 may be performed with UE-B 110-B, UE 110, or apparatus 500.

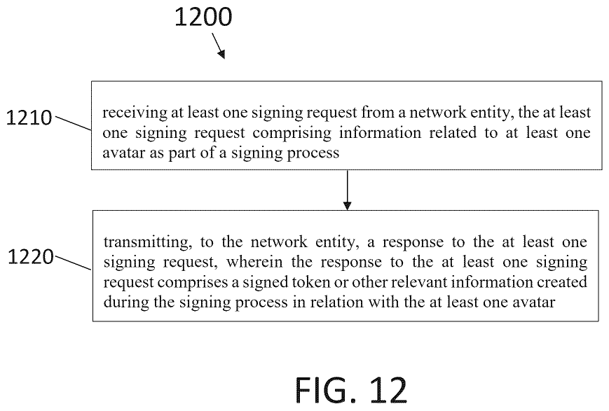

FIG. 12 is an example method 1200, based on the example embodiments described herein. At 1210, the method includes receiving at least one signing request from a network entity, the at least one signing request comprising information related to at least one avatar as part of a signing process. At 1220, the method includes transmitting, to the network entity, a response to the at least one signing request, wherein the response to the at least one signing request comprises a signed token or other relevant information created during the signing process in relation with the at least one avatar. Method 1200 may be performed with signing server 210, RAN node 170, one or more network elements 190, or apparatus 500.

The following examples are provided and described herein.

Example 1. An apparatus including: at least one processor; and at least one memory storing instructions that, when executed by the at least one processor, cause the apparatus at least to: receive, from a first user equipment, a session initiation protocol invite request to a second user equipment, wherein the session initiation protocol invite request comprises information related to at least one avatar; transmit at least one signing request to a signing server, the at least one signing request comprising the information related to the at least one avatar as part of a signing process; receive, from the signing server, a response to the at least one signing request, wherein the response to the at least one signing request comprises a signed token or other relevant information created during the signing process in relation with the at least one avatar; and forward, to a network entity, the session initiation protocol invite request with an identity header, wherein the identity header comprises the signed token or the other relevant information created during the signing process in relation with the at least one avatar.

Example 2. The apparatus of example 1, wherein the at least one signing request is based on at least one or more of: a secure telephone identity revisited standard, or a signature based handling of asserted information using tokens standard.

Example 3. The apparatus of any of examples 1 to 2, wherein the information related to the at least one avatar within the at least one signing request comprises at least one or more of: an avatar identifier, or an avatar uniform resource identifier, or avatar content.

Example 4. The apparatus of any of examples 1 to 3, wherein the information related to the at least one avatar within the session initiation protocol invite request is transmitted in a call-info header.

Example 5. The apparatus of any of examples 1 to 4, wherein the information related to the at least one avatar within the session initiation protocol invite request is trusted or retrieved from a trusted entity or stored and retrieved from a trusted network function.

Example 6. The apparatus of example 5, wherein the information related to the at least one avatar within the session initiation protocol invite request is stored in a home subscriber server.

Example 7. The apparatus of any of examples 3 to 6, wherein the instructions, when executed by the at least one processor, cause the apparatus to perform at least one or more of: pass the avatar identifier by reference within the at least one signing request to the signing server, or pass the avatar uniform resource identifier by reference within the at least one signing request to the signing server, or pass the avatar content by value within the at least one signing request to the signing server.

Example 8. The apparatus of any of examples 1 to 7, wherein the instructions, when executed by the at least one processor, cause the apparatus at least to: transmit one or multiple signing requests to the signing server, in response to there being multiple avatars within the session initiation protocol invite request, wherein a signing request of the multiple signing requests comprises information related to an avatar; and forward, to the network entity, the session initiation protocol invite request with one or multiple identity headers, wherein an identity header of the multiple identity headers comprises the signed token and information related to the avatar, in response to there being multiple avatars within the session initiation protocol invite request.

Example 9. The apparatus of any of examples 1 to 8, wherein the at least one signing request is dedicated to the information related to the at least one avatar, and differs from a calling party identifier signing request.

Example 10. The apparatus of any of examples 1 to 9, wherein the instructions, when executed by the at least one processor, cause the apparatus at least to: transmit, to the second user equipment, the identity header related to a verified avatar associated with the session initiation protocol invite request.

Example 11. The apparatus of any of examples 1 to 10, wherein the instructions, when executed by the at least one processor, cause the apparatus at least to: transmit, to the second user equipment, the signed token or the other relevant information created during the signing process.

Example 12. The apparatus of any of examples 1 to 11, wherein the instructions, when executed by the at least one processor, cause the apparatus at least to: receive, from the second user equipment or terminating network, an indication that the second user equipment or terminating network was able to verify at least one avatar.

Example 13. An apparatus including: at least one processor; and at least one memory storing instructions that, when executed by the at least one processor, cause the apparatus at least to: receive, from a network entity, a session initiation protocol invite request with an identity header, wherein the identity header comprises a signed token or other relevant information created during a signing process, wherein the session initiation protocol invite request comprises information related to at least one avatar and is associated with a first user equipment; transmit, to a verification server, a verification request to verify the information related to the at least one avatar, wherein the verification request comprises the identity header comprising the signed token or other relevant information created during the signing process, the session initiation protocol invite request associated with the first user equipment, and the information related to the at least one avatar; receive, from the verification server, an indication of whether the information related to the at least one avatar is verified; and forward, to a second user equipment, the session initiation protocol invite request and the information related to the at least one avatar, in response to receiving an indication from the verification server that the information related to the at least one avatar is verified.

Example 14. The apparatus of example 13, wherein the instructions, when executed by the at least one processor, cause the apparatus at least to: receive, from the verification server, an indication that the information related to the at least one avatar is not verified.

Example 15. The apparatus of example 14, wherein the instructions, when executed by the at least one processor, cause the apparatus at least to: determine to not forward the session initiation protocol invite request to the second user equipment, in response to receiving from the verification server the indication that the information related to the at least one avatar is not verified.

Example 16. The apparatus of any of examples 14 to 15, wherein the instructions, when executed by the at least one processor, cause the apparatus at least to: determine whether an identity of an originating party associated with the first user equipment is verified; determine to forward the session initiation protocol invite request to the second user equipment without an avatar, in response to receiving from the verification server the indication that the information related to the at least one avatar is not verified, and in response to determining that the identity of the originating party associated with the first user equipment is verified.

Example 17. The apparatus of any of examples 14 to 16, wherein the instructions, when executed by the at least one processor, cause the apparatus at least to: determine to forward the session initiation protocol invite request to the second user equipment with an unverified avatar, in response to receiving from the verification server the indication that the information related to the at least one avatar is not verified; and transmit, to the second user equipment, an indication that the transmitted avatar is unverified.

Example 18. The apparatus of any of examples 13 to 17, wherein the instructions, when executed by the at least one processor, cause the apparatus at least to: download the verified avatar from a uniform resource locator, in response to receiving the indication from the verification server that the information related to the at least one avatar is verified.

Example 19. The apparatus of any of examples 13 to 18, wherein the instructions, when executed by the at least one processor, cause the apparatus at least to: receive, from the second user equipment or terminating network, an indication that the second user equipment or terminating network was able to verify at least one avatar.

Example 20. An apparatus including: at least one processor; and at least one memory storing instructions that, when executed by the at least one processor, cause the apparatus at least to: receive, from a network entity, a verification request to verify information related to at least one avatar, wherein the verification request comprises an identity header comprising a signed token or other relevant information created during a signing process, a session initiation protocol invite request associated with a first user equipment, and the information related to at least one avatar; determine whether the information related to the at least one avatar is verified, based on the identity header and the information related to the at least one avatar; and transmit, to the network entity, an indication of whether the information related to the at least one avatar is verified.

Example 21. The apparatus of example 20, wherein the instructions, when executed by the at least one processor, cause the apparatus at least to: compare avatar information within the identity header with avatar information within the session initiation protocol invite request; and determine that the information related to the at least one avatar is verified, in response to the avatar information within the identity header matching the avatar information within the session initiation protocol invite request.

Example 22. An apparatus including: at least one processor; and at least one memory storing instructions that, when executed by the at least one processor, cause the apparatus at least to: transmit, from a first user equipment to a network entity, a session initiation protocol invite request to a second user equipment, wherein the session initiation protocol invite request comprises information related to at least one avatar as part of a signing process, and wherein the apparatus comprises the first user equipment; receive, from the network entity, an identity header related to the at least one avatar, the at least one avatar being verified; and store the identity header related to the verified at least one avatar for at least one other session initiation protocol invite request.

Example 23. The apparatus of example 22, wherein the instructions, when executed by the at least one processor, cause the apparatus at least to: transmit, to the network entity, the at least one other session initiation protocol invite request with the identity header.

Example 24. The apparatus of any of examples 22 to 23, wherein the instructions, when executed by the at least one processor, cause the apparatus at least to: receive a signed token or other relevant information created during the signing process associated with the at least one avatar; and store the signed token or other relevant information created during the signing process associated with the at least one avatar; and transmit, to the network entity, the at least one other session initiation protocol invite request with the signed token and other relevant information created during the signing process.

Example 25. An apparatus including: at least one processor; and at least one memory storing instructions that, when executed by the at least one processor, cause the apparatus at least to: receive, from a terminating network entity, a session initiation protocol invite request associated with a user equipment and a verified avatar; and download, use, or view information related to the verified avatar with the session initiation protocol invite request associated with the user equipment.

Example 26. The apparatus of example 25, wherein the instructions, when executed by the at least one processor, cause the apparatus at least to: receive, from the terminating network entity, a session initiation protocol invite request associated with another user equipment without a verified avatar, in response to an identity of an originating party associated with the another user equipment being valid.

Example 27. The apparatus of any of examples 25 to 26, wherein the instructions, when executed by the at least one processor, cause the apparatus at least to: receive, from the terminating network entity, a session initiation protocol invite request associated with another user equipment with an unverified avatar; and receive, from the terminating network entity, an indication that the received avatar is unverified.

Example 28. An apparatus including: at least one processor; and at least one memory storing instructions that, when executed by the at least one processor, cause the apparatus at least to: receive at least one signing request from a network entity, the at least one signing request comprising information related to at least one avatar as part of a signing process; and transmit, to the network entity, a response to the at least one signing request, wherein the response to the at least one signing request comprises a signed token or other relevant information created during the signing process in relation with the at least one avatar.

Example 29. The apparatus of example 28, wherein the at least one signing request is based on at least one or more of: a secure telephone identity revisited standard, or a signature based handling of asserted information using tokens standard.

Example 30. The apparatus of any of examples 28 to 29, wherein the information related to the at least one avatar within the at least one signing request comprises at least one or more of: an avatar identifier, or an avatar uniform resource identifier, or avatar content.

Example 31. The apparatus of example 30, wherein the instructions, when executed by the at least one processor, cause the apparatus to perform at least one or more of: receive the avatar identifier by reference within the at least one signing request, or receive the avatar uniform resource identifier by reference within the at least one signing request, or receive the avatar content by value within the at least one signing request.

Example 32. The apparatus of example 31, wherein the instructions, when executed by the at least one processor, cause the apparatus to perform at least: download or retrieve the avatar content, in response to receiving the avatar identifier by reference within the at least one signing request.

Example 33. The apparatus of any of examples 28 to 32, wherein the instructions, when executed by the at least one processor, cause the apparatus at least to: receive one or multiple signing requests from the network entity associated with multiple respective avatars, wherein a signing request of the multiple signing requests comprises a respective avatar; and transmit, to the network entity, one or multiple respective responses to the multiple respective signing requests, wherein a respective response to a respective signing request comprises a respective signed token or respective other relevant information created during the signing process.

Example 34. The apparatus of any of examples 28 to 33, wherein the at least one signing request is dedicated to the information related to the at least one avatar, and differs from a calling party identifier signing request.

Example 35. A method including: receiving, from a first user equipment, a session initiation protocol invite request to a second user equipment, wherein the session initiation protocol invite request comprises information related to at least one avatar; transmitting at least one signing request to a signing server, the at least one signing request comprising the information related to the at least one avatar as part of a signing process; receiving, from the signing server, a response to the at least one signing request, wherein the response to the at least one signing request comprises a signed token or other relevant information created during the signing process in relation with the at least one avatar; and forwarding, to a network entity, the session initiation protocol invite request with an identity header, wherein the identity header comprises the signed token or the other relevant information created during the signing process in relation with the at least one avatar.

Example 36. A method including: receiving, from a network entity, a session initiation protocol invite request with an identity header, wherein the identity header comprises a signed token or other relevant information created during a signing process, wherein the session initiation protocol invite request comprises information related to at least one avatar and is associated with a first user equipment; transmitting, to a verification server, a verification request to verify the information related to the at least one avatar, wherein the verification request comprises the identity header comprising the signed token or other relevant information created during the signing process, the session initiation protocol invite request associated with the first user equipment, and the information related to the at least one avatar; receiving, from the verification server, an indication of whether the information related to the at least one avatar is verified; and forwarding, to a second user equipment, the session initiation protocol invite request and the information related to the at least one avatar, in response to receiving an indication from the verification server that the information related to the at least one avatar is verified.

Example 37. A method including: receiving, from a network entity, a verification request to verify information related to at least one avatar, wherein the verification request comprises an identity header comprising a signed token or other relevant information created during a signing process, a session initiation protocol invite request associated with a first user equipment, and the information related to at least one avatar; determining whether the information related to the at least one avatar is verified, based on the identity header and the information related to the at least one avatar; and transmitting, to the network entity, an indication of whether the information related to the at least one avatar is verified.

Example 38. A method including: transmitting, from a first user equipment to a network entity, a session initiation protocol invite request to a second user equipment, wherein the session initiation protocol invite request comprises information related to at least one avatar as part of a signing process; receiving, from the network entity, an identity header related to the at least one avatar, the at least one avatar being verified; and storing the identity header related to the verified at least one avatar for at least one other session initiation protocol invite request.

Example 39. A method including: receiving, from a terminating network entity, a session initiation protocol invite request associated with a user equipment and a verified avatar; and downloading, using, or viewing information related to the verified avatar with the session initiation protocol invite request associated with the user equipment.

Example 40. A method including: receiving at least one signing request from a network entity, the at least one signing request comprising information related to at least one avatar as part of a signing process; and transmitting, to the network entity, a response to the at least one signing request, wherein the response to the at least one signing request comprises a signed token or other relevant information created during the signing process in relation with the at least one avatar.

Example 41. An apparatus including: means for receiving, from a first user equipment, a session initiation protocol invite request to a second user equipment, wherein the session initiation protocol invite request comprises information related to at least one avatar; means for transmitting at least one signing request to a signing server, the at least one signing request comprising the information related to the at least one avatar as part of a signing process; means for receiving, from the signing server, a response to the at least one signing request, wherein the response to the at least one signing request comprises a signed token or other relevant information created during the signing process in relation with the at least one avatar; and means for forwarding, to a network entity, the session initiation protocol invite request with an identity header, wherein the identity header comprises the signed token or the other relevant information created during the signing process in relation with the at least one avatar.

Example 42. An apparatus including: means for receiving, from a network entity, a session initiation protocol invite request with an identity header, wherein the identity header comprises a signed token or other relevant information created during a signing process, wherein the session initiation protocol invite request comprises information related to at least one avatar and is associated with a first user equipment; means for transmitting, to a verification server, a verification request to verify the information related to the at least one avatar, wherein the verification request comprises the identity header comprising the signed token or other relevant information created during the signing process, the session initiation protocol invite request associated with the first user equipment, and the information related to the at least one avatar; means for receiving, from the verification server, an indication of whether the information related to the at least one avatar is verified; and means for forwarding, to a second user equipment, the session initiation protocol invite request and the information related to the at least one avatar, in response to receiving an indication from the verification server that the information related to the at least one avatar is verified.

Example 43. An apparatus including: means for receiving, from a network entity, a verification request to verify information related to at least one avatar, wherein the verification request comprises an identity header comprising a signed token or other relevant information created during a signing process, a session initiation protocol invite request associated with a first user equipment, and the information related to at least one avatar; means for determining whether the information related to the at least one avatar is verified, based on the identity header and the information related to the at least one avatar; and means for transmitting, to the network entity, an indication of whether the information related to the at least one avatar is verified.

Example 44. An apparatus including: means for transmitting, from a first user equipment to a network entity, a session initiation protocol invite request to a second user equipment, wherein the session initiation protocol invite request comprises information related to at least one avatar as part of a signing process, and wherein the apparatus comprises the first user equipment; means for receiving, from the network entity, an identity header related to the at least one avatar, the at least one avatar being verified; and means for storing the identity header related to the verified at least one avatar for at least one other session initiation protocol invite request.

Example 45. An apparatus including: means for receiving, from a terminating network entity, a session initiation protocol invite request associated with a user equipment and a verified avatar; and means for downloading, using, or viewing information related to the verified avatar with the session initiation protocol invite request associated with the user equipment.

Example 46. An apparatus including: means for receiving at least one signing request from a network entity, the at least one signing request comprising information related to at least one avatar as part of a signing process; and means for transmitting, to the network entity, a response to the at least one signing request, wherein the response to the at least one signing request comprises a signed token or other relevant information created during the signing process in relation with the at least one avatar.

Example 47. A non-transitory computer readable medium including program instructions stored thereon for performing at least the following: receiving, from a first user equipment, a session initiation protocol invite request to a second user equipment, wherein the session initiation protocol invite request comprises information related to at least one avatar; transmitting at least one signing request to a signing server, the at least one signing request comprising the information related to the at least one avatar as part of a signing process; receiving, from the signing server, a response to the at least one signing request, wherein the response to the at least one signing request comprises a signed token or other relevant information created during the signing process in relation with the at least one avatar; and forwarding, to a network entity, the session initiation protocol invite request with an identity header, wherein the identity header comprises the signed token or the other relevant information created during the signing process in relation with the at least one avatar.

Example 48. A non-transitory computer readable medium including program instructions stored thereon for performing at least the following: receiving, from a network entity, a session initiation protocol invite request with an identity header, wherein the identity header comprises a signed token or other relevant information created during a signing process, wherein the session initiation protocol invite request comprises information related to at least one avatar and is associated with a first user equipment; transmitting, to a verification server, a verification request to verify the information related to the at least one avatar, wherein the verification request comprises the identity header comprising the signed token or other relevant information created during the signing process, the session initiation protocol invite request associated with the first user equipment, and the information related to the at least one avatar; receiving, from the verification server, an indication of whether the information related to the at least one avatar is verified; and forwarding, to a second user equipment, the session initiation protocol invite request and the information related to the at least one avatar, in response to receiving an indication from the verification server that the information related to the at least one avatar is verified.

Example 49. A non-transitory computer readable medium including program instructions stored thereon for performing at least the following: receiving, from a network entity, a verification request to verify information related to at least one avatar, wherein the verification request comprises an identity header comprising a signed token or other relevant information created during a signing process, a session initiation protocol invite request associated with a first user equipment, and the information related to at least one avatar; determining whether the information related to the at least one avatar is verified, based on the identity header and the information related to the at least one avatar; and transmitting, to the network entity, an indication of whether the information related to the at least one avatar is verified.

Example 50. A non-transitory computer readable medium including program instructions stored thereon for performing at least the following: transmitting, from a first user equipment to a network entity, a session initiation protocol invite request to a second user equipment, wherein the session initiation protocol invite request comprises information related to at least one avatar as part of a signing process; receiving, from the network entity, an identity header related to the at least one avatar, the at least one avatar being verified; and storing the identity header related to the verified at least one avatar for at least one other session initiation protocol invite request.

Example 51. A non-transitory computer readable medium including program instructions stored thereon for performing at least the following: receiving, from a terminating network entity, a session initiation protocol invite request associated with a user equipment and a verified avatar; and downloading, using, or viewing information related to the verified avatar with the session initiation protocol invite request associated with the user equipment.

Example 52. A non-transitory computer readable medium including program instructions stored thereon for performing at least the following: receiving at least one signing request from a network entity, the at least one signing request comprising information related to at least one avatar as part of a signing process; and transmitting, to the network entity, a response to the at least one signing request, wherein the response to the at least one signing request comprises a signed token or other relevant information created during the signing process in relation with the at least one avatar.

References to a ‘computer’, ‘processor’, etc. should be understood to encompass not only computers having different architectures such as single/multi-processor architectures and sequential or parallel architectures but also specialized circuits such as field-programmable gate arrays (FPGAs), application specific circuits (ASICs), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

The memories as described herein may be implemented using any suitable data storage technology, such as semiconductor based memory devices, flash memory, magnetic memory devices and systems, optical memory devices and systems, non-transitory memory, transitory memory, fixed memory and removable memory. The memories may comprise a database for storing data.

As used herein, the term ‘circuitry’ may refer to the following: (a) hardware circuit implementations, such as implementations in analog and/or digital circuitry, and (b) combinations of circuits and software (and/or firmware), such as (as applicable): (i) a combination of processor(s) or (ii) portions of processor(s)/software including digital signal processor(s), software, and memories that work together to cause an apparatus to perform various functions, and (c) circuits, such as a microprocessor(s) or a portion of a microprocessor(s), that require software or firmware for operation, even if the software or firmware is not physically present. As a further example, as used herein, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device.

It should be understood that the foregoing description is only illustrative. Various alternatives and modifications may be devised by those skilled in the art. For example, features recited in the various dependent claims could be combined with each other in any suitable combination(s). In addition, features from different example embodiments described above could be selectively combined into a new example embodiment. Accordingly, this description is intended to embrace all such alternatives, modifications and variances which fall within the scope of the appended claims.

The following acronyms and abbreviations that may be found in the specification and/or the drawing figures are given as follows (the abbreviations and acronyms may be appended with each other or with other characters using e.g. a dash, hyphen, slash, or number, and may be case insensitive):

| | |
|---|---|
| 2D | two dimensional |
| 3D | three dimensional |
| 3GPP | third generation partnership project |
| 4G | fourth generation |
| 5G | fifth generation |
| 5GC | 5G core network |
| A2P | application to person |
| AGW | access gateway |
| AR | augmented reality |
| AMF | access and mobility management function |
| AS | application server |
| ASIC | application-specific integrated circuit |
| CD | compact/computer disc |
| CPU | central processing unit |
| CSCF | call session control function |
| CU | central unit or centralized unit |
| DAC | digital asset container |
| DC | data channel |
| DCAR | DC application repository |
| DCSF | DC signaling function |
| DSP | digital signal processor |
| DU | distributed unit |
| DVD | digital versatile disc |
| eNB | evolved Node B (e.g., an LTE base station) |
| EN-DC | E-UTRAN new radio - dual connectivity |
| en-gNB | node providing NR user plane and |
| | control plane protocol terminations |
| | towards the UE, and acting as a |
| | secondary node in EN-DC |
| E-UTRA | evolved UMTS terrestrial radio |
| | access, i.e., the LTE radio access |
| | technology |
| E-UTRAN | E-UTRA network |
| F1 | interface between the CU and the DU |
| FACS | facial action coding system |
| FPGA | field-programmable gate array |
| glTF | graphics library transmission format |
| gNB | base station for 5G/NR, i.e., a node |
| | providing NR user plane and control |
| | plane protocol terminations towards |
| | the UE, and connected via the NG |
| | interface to the 5GC |
| HSS | home subscriber server |
| HTTP | hypertext transfer protocol |
| IAB | integrated access and backhaul |
| IBCF | interconnect border control function |
| ID | identifier |
| IETF | internet engineering task force |
| I/F | interface |
| IMPU | IMS public user identity |
| IMS | IP multimedia subsystem |
| I/O | input/output |
| IP | internet protocol |
| I/S | interrogating/serving |
| ISC | IP multimedia subsystem service control interface |
| json | JavaScript Object Notation |
| LMF | location management function |
| LRDD | link-based resource descriptor discovery |
| LTE | long term evolution (4G) |
| MAC | medium access control |
| MDC | media data channel |
| MF | media function |
| MME | mobility management entity |
| Mr′/Cr | SIP based reference point |
| | between IMS AS and MRF. |
| MRF | media resource function |
| MRO | mobility robustness optimization |
| Ms | reference point used between attestation, |
| | an IBCF and an AS for identity |
| | identity signing, and signature verification |
| NCE | network control element |
| NEF | network exposure function |
| NF | network function |
| ng or NG | new generation |
| ng-eNB | new generation eNB |
| NG-RAN | new generation radio access network |
| NR | new radio |
| N/W | network |
| P-Asserted-Identity | header field that contains a URI and |
| | an optional display-name |
| PASSporT | personal assertion token |
| P-CSCF | proxy call session control function |
| PDA | personal digital assistant |
| PDCP | packet data convergence protocol |
| PHY | physical layer |
| PLMN | public land mobile network |
| ppt | PASSporT extension |
| RAM | random access memory |
| RAN | radio access network |
| RAT | radio access technology |
| RCD | rich call data |
| Rel | release |
| RFC | request for comments |
| RLC | radio link control |
| ROM | read-only memory |
| RRC | radio resource control |
| RU | radio unit |
| Rx | receiver or reception |
| SA | system aspects |
| SDAP | service data adaptation protocol |
| SDP | session description protocol |
| SGW | serving gateway |
| SHAKEN | Signature-based Handling of Asserted |
| | information using toKENs |
| SIP | session initiation protocol |
| SMF | session management function |
| SON | self-organizing/optimizing network |
| STI-AS | secure telephone identity - authentication service |
| STIR | secure telephone identity revisited |
| STI-VS | secure telephone identity - verification service |
| Tel | telephone |
| TR | technical report |
| TrGW | transition gateway |
| TRP | transmission reception point |
| TS | technical specification |
| Tx, TX | transmitter or transmission |
| UAV | unmanned aerial vehicle |
| UDM | unified data management |
| UE | user equipment (e.g., a wireless, |
| | typically mobile device) |
| UI | user interface |
| UMTS | Universal Mobile Telecommunications System |
| UPF | user plane function |
| URI | uniform resource identifier |
| URL | uniform resource locator |
| URN | uniform resource name |
| USB | universal serial bus |
| UUID | universally unique identifier |
| VR | virtual reality |
| VRM | virtual reality model |
| X2 | network interface between RAN nodes |
| | and between RAN and the core network |
| XML | extensible markup language |
| Xn | network interface between NG-RAN nodes |
| XR | extended reality |

We claim:

1. An apparatus comprising:
at least one processor; and
at least one memory storing instructions that, when executed by the at least one processor, cause the apparatus at least to:
receive, from a first user equipment, a session initiation protocol invite request destined for a second user equipment, wherein the session initiation protocol invite request comprises information related to at least one avatar;
transmit at least one signing request to a signing server, the at least one signing request comprising the information related to the at least one avatar as part of a signing process;
receive, from the signing server, a response to the at least one signing request, wherein the response to the at least one signing request comprises a signed token or other relevant information created during the signing process in relation with the at least one avatar; and
forward, to a network entity, the session initiation protocol invite request with an identity header, wherein the identity header comprises the signed token or the other relevant information created during the signing process in relation with the at least one avatar.

2. The apparatus of claim 1, wherein the at least one signing request is based on at least one or more of:
a secure telephone identity revisited standard, or
a signature based handling of asserted information using tokens standard.

3. The apparatus of claim 1, wherein the information related to the at least one avatar within the at least one signing request comprises at least one or more of:
an avatar identifier, or
an avatar uniform resource identifier, or
avatar content.

4. The apparatus of claim 1, wherein the information related to the at least one avatar within the session initiation protocol invite request is transmitted in a call-info header.

5. The apparatus of claim 1, wherein the information related to the at least one avatar within the session initiation protocol invite request is trusted or retrieved from a trusted entity or stored and retrieved from a trusted network function; and
wherein the information related to the at least one avatar within the session initiation protocol invite request is stored in a home subscriber server.

6. The apparatus of claim 1, wherein the instructions, when executed by the at least one processor, cause the apparatus at least to:
transmit one or multiple signing requests to the signing server, in response to there being multiple avatars within the session initiation protocol invite request, wherein a signing request of the multiple signing requests comprises information related to an avatar; and
forward, to the network entity, the session initiation protocol invite request with one or multiple identity headers, wherein an identity header of the multiple identity headers comprises the signed token and information related to the avatar, in response to there being multiple avatars within the session initiation protocol invite request.

7. The apparatus of claim 1, wherein the at least one signing request is dedicated to the information related to the at least one avatar, and differs from a calling party identifier signing request.

8. The apparatus of claim 1, wherein the instructions, when executed by the at least one processor, cause the apparatus at least to:
transmit, to the second user equipment, the identity header related to a verified avatar associated with the session initiation protocol invite request.

9. The apparatus of claim 1, wherein the instructions, when executed by the at least one processor, cause the apparatus at least to:
transmit, to the second user equipment, the signed token or the other relevant information created during the signing process.

10. The apparatus of claim 1, wherein the instructions, when executed by the at least one processor, cause the apparatus at least to:
receive, from the second user equipment or terminating network, an indication that the second user equipment or terminating network was able to verify at least one avatar.

11. An apparatus comprising:
at least one processor; and
at least one memory storing instructions that, when executed by the at least one processor, cause the apparatus at least to:
receive, from a network entity, a session initiation protocol invite request with an identity header, wherein the identity header comprises a signed token or other relevant information created during a signing process, wherein the session initiation protocol invite request comprises information related to at least one avatar and is associated with a first user equipment;
transmit, to a verification server, a verification request to verify the information related to the at least one avatar, wherein the verification request comprises the identity header comprising the signed token or other relevant information created during the signing process, the session initiation protocol invite request associated with the first user equipment, and the information related to the at least one avatar;
receive, from the verification server, an indication of whether the information related to the at least one avatar is verified; and
forward, to a second user equipment, the session initiation protocol invite request and the information related to the at least one avatar, in response to receiving an indication from the verification server that the information related to the at least one avatar is verified.

12. The apparatus of claim 11, wherein the instructions, when executed by the at least one processor, cause the apparatus at least to:
receive, from the verification server, an indication that the information related to the at least one avatar is not verified.

13. The apparatus of claim 12, wherein the instructions, when executed by the at least one processor, cause the apparatus at least to:
determine to not forward the session initiation protocol invite request to the second user equipment, in response to receiving from the verification server the indication that the information related to the at least one avatar is not verified.

14. The apparatus of claim 12, wherein the instructions, when executed by the at least one processor, cause the apparatus at least to:
determine whether an identity of an originating party associated with the first user equipment is verified;
determine to forward the session initiation protocol invite request to the second user equipment without an avatar, in response to receiving from the verification server the indication that the information related to the at least one avatar is not verified, and in response to determining that the identity of the originating party associated with the first user equipment is verified.

15. The apparatus of claim 12, wherein the instructions, when executed by the at least one processor, cause the apparatus at least to:
determine to forward the session initiation protocol invite request to the second user equipment with an unverified avatar, in response to receiving from the verification server the indication that the information related to the at least one avatar is not verified; and
transmit, to the second user equipment, an indication that the transmitted avatar is unverified.

16. The apparatus of claim 11, wherein the instructions, when executed by the at least one processor, cause the apparatus at least to:
download the verified avatar from a uniform resource locator, in response to receiving the indication from the verification server that the information related to the at least one avatar is verified.

17. The apparatus of claim 11, wherein the instructions, when executed by the at least one processor, cause the apparatus at least to:
receive, from the second user equipment or terminating network, an indication that the second user equipment or terminating network was able to verify at least one avatar.

18. An apparatus comprising:
at least one processor; and
at least one memory storing instructions that, when executed by the at least one processor, cause the apparatus at least to:
transmit, from a first user equipment to a network entity, a session initiation protocol invite request to a second user equipment, wherein the session initiation protocol invite request comprises information related to at least one avatar as part of a signing process, and wherein the apparatus comprises the first user equipment;
receive, from the network entity, an identity header related to the at least one avatar, the at least one avatar being verified; and
store the identity header related to the verified at least one avatar for at least one other session initiation protocol invite request.

19. The apparatus of claim 18, wherein the instructions, when executed by the at least one processor, cause the apparatus at least to:
transmit, to the network entity, the at least one other session initiation protocol invite request with the identity header.

20. The apparatus of claim 18, wherein the instructions, when executed by the at least one processor, cause the apparatus at least to:
receive a signed token or other relevant information created during the signing process associated with the at least one avatar; and
store the signed token or other relevant information created during the signing process associated with the at least one avatar; and
transmit, to the network entity, the at least one other session initiation protocol invite request with the signed token and other relevant information created during the signing process.
